(19) United States
(12) Patent Application Publication
(10) Pub. No.: US 2026/0143567 A1
(43) Pub. Date: May 21, 2026

(54) SYSTEMS FOR DIRECTLY HEATING ELECTRIC TUBES FOR HYDROCARBON UPGRADING

(71) Applicant: Dow Global Technologies LLC, Midland, MI (US)

(72) Inventors: Huan T. Ngo, Fort Saskatchewan (CA); Quan Yuan, Sugarland, TX (US); Georgios Bellos, Hoek (NL); Brent A. Hancharyk, Missouri City, TX (US); Ryan C. Johnson, Rancho Cucamonga, CA (US); Albert D. Harvey, III, Spring, TX (US); David Burns, Huntsville, TX (US)

(73) Assignee: Dow Global Technologies LLC, Midland, MI (US)

(21) Appl. No.: 19/121,237

(22) PCT Filed: Oct. 17, 2022
(86) PCT No.: PCT/GR2022/000055

§ 371 Date: Apr. 15, 2025

(51) Int. Cl. H05B 3/42

(52) U.S. Cl. CPC H05B 3/42

(57) ABSTRACT

A heating apparatus includes a pair of electrically conductive tubes, a feed channel having a fluid entrance and a grounded connection, a product channel having a fluid exit and a grounded connection, and a DC current voltage source. The feed channel is fluidly connected to inlets of the pair of electrically conductive tubes and the product channel is fluidly connected to outlets of the pair of electrically conductive tubes. The pair of electrically conductive tubes include a first electrically conductive tube and a second electrically conductive tube connected in series and the DC current voltage source is electrically connected to the first electrically conductive tube and the second electrically conductive tube.

### TECHNICAL FIELD

Embodiments of the present disclosure generally relate to systems and processes by which hydrocarbons are upgraded.

### BACKGROUND

Ethylene is widely used as an intermediate in the petrochemical industry and its production exceeds that of any other organic compound. Much of ethylene production goes to the manufacture of ethylene oxide, ethylene dichloride and polyethylene, which are precursors to a multitude of everyday consumer products. Despite various improvements over the years in thermal efficiency, reliability and safety, steam cracking furnaces used to form hydrocarbons such as ethylene remain heavily reliant on combustion of fossil fuels to provide process heat leading to substantial greenhouse gas emissions.

The steam cracking process to produce ethylene requires roughly half the energy required of competing processes (e.g., direct C₁ conversion technologies) and is projected to remain as the most energy efficient process. CO₂ emissions from steam cracking of ethane ranges from 0.76 to 1.06 ton-CO₂ per ton-ethylene produced and is lower than steam cracking of naphtha and alternates C₁-based routes to ethylene. At projected rates of ethylene production CO₂ emissions from conventional steam cracking could exceed 300 Mta-CO₂ in the coming years. About 85% of the CO₂ emissions in the steam cracking process are emitted in the radiant combustion furnace section. In conventional radiant furnaces, numerous fuel gas burners are deployed to efficiently radiate heat from the combustion process through tubular reactor walls containing flowing feedstocks (e.g., hydrocarbon and steam) and product gases, providing heat to perform the required endothermic chemical reactions.

The growth and availability of renewable electricity creates an opportunity to use renewable energy in the formation of ethylene, eliminating the need to burn fossil fuels, and achieve a lower emission process. Various electric heating technologies such as impedance, induction, plasma, and microwaves may be used in place of combustion fired heating to generate and effectively transfer heat into the radiant coils of steam cracking furnaces. However, needs still exist for systems that can form ethylene and other hydrocarbons via heating with renewable electric sources.

### SUMMARY

In the application of direct electrical heating to large scale steam cracking processes, large amount of electrical current and power are required. A key challenge is how to apply direct electrical heating efficiently and strategically to large scale steam cracker via a heater consisting of multiple conduits requiring many hundreds of Megawatts of electrical power. The heating apparatuses of the present disclosure reduce the total required current of the power supply by half, while avoiding the use of electrical isolating devices (such as isolating flanges) and create multiple heating zones to deliver tailored power and heat load to each electrically conductive tube of the heating apparatus. Reducing the required electrical current results in increased efficiency for the power supply and associated electrical connections and supporting equipment. Further, facilitating a tailored heat injection rate to the electrically conductive tubes increases desirable product yields.

Embodiments of this disclosure include heating apparatuses including a pair of electrically conductive tubes, a feed channel having a fluid entrance and a grounded connection, a product channel having a fluid exit and a grounded connection, and a DC current voltage source. The feed channel is fluidly connected to inlets of the pair of electrically conductive tubes and the product channel is fluidly connected to outlets of the pair of electrically conductive tubes. The pair of electrically conductive tubes include a first electrically conductive tube and a second electrically conductive tube connected in series and the DC current voltage source is electrically connected to the first electrically conductive tube and the second electrically conductive tube.

Additional embodiments of this disclosure include processes for upgrading a hydrocarbon fluid including introducing a hydrocarbon fluid into a fluid entrance of a feed channel, introducing a first portion of the hydrocarbon fluid into an inlet of a first electrically conductive tube, and introducing a second portion of the hydrocarbon fluid into an inlet of a second electrically conductive tube. The processes further include applying DC current to the first electrically conductive tube to heat the first portion of the hydrocarbon fluid within the electrically conductive tube to reaction temperature to form a first product stream and applying DC current to the second electrically conductive tube to heat the second portion of the hydrocarbon fluid within the electrically conductive tube to reaction temperature to form a second product stream. The processes further include introducing the first product stream into a product channel through an outlet of the first electrically conductive tube and introducing the second product stream into the product channel through an outlet of the second electrically conductive tube.

### BRIEF DESCRIPTION OF FIGURES

The following detailed description of specific embodiments of the present disclosure can be best understood when read in conjunction with the following drawings, in which:

FIG. 1 is a schematic view of a process and apparatus for upgrading hydrocarbons, according to the present embodiments;

FIG. 2A is a first side view of an apparatus for upgrading hydrocarbons according to the present embodiments;

FIG. 2B is a second side view of an apparatus for upgrading hydrocarbons according to the present embodiments;

FIG. 3A is a first plan view of an apparatus for upgrading hydrocarbons according to the present embodiments;

FIG. 3B is a second plan view of an apparatus for upgrading hydrocarbons according to the present embodiments;

FIG. 4 is a graphical depiction of ethylene yield over cracking temperature, according to the present embodiments;

FIG. 5 is a graphical depiction of the process gas temperature profile, according to the present embodiments; and

FIG. 6 is a graphical depiction of ethylene yield, according to the present embodiments.

### DETAILED DESCRIPTION

Embodiments of the present disclosure are directed to heating apparatuses including a pair of electrically conductive tubes, a feed channel having a fluid entrance and a grounded connection, a product channel having a fluid exit and a grounded connection, and a DC current voltage source. The feed channel is fluidly connected to inlets of the pair of electrically conductive tubes and the product channel is fluidly connected to outlets of the pair of electrically conductive tubes. The pair of electrically conductive tubes include a first electrically conductive tube and a second electrically conductive tube connected in series and the DC current voltage source is electrically connected to the first electrically conductive tube and the second electrically conductive tube. It should be understood that the heating apparatuses of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

Embodiments of the present disclosure are also directed to processes for upgrading a hydrocarbon fluid including introducing a hydrocarbon fluid into a fluid entrance of a feed channel, introducing a first portion of the hydrocarbon fluid into an inlet of a first electrically conductive tube, and introducing a second portion of the hydrocarbon fluid into an inlet of a second electrically conductive tube. The processes further include applying DC current to the first electrically conductive tube to heat the first portion of the hydrocarbon fluid within the electrically conductive tube to reaction temperature to form a first product stream and applying DC current to the second electrically conductive tube to heat the second portion of the hydrocarbon fluid within the electrically conductive tube to reaction temperature to form a second product stream. The processes further include introducing the first product stream into a product channel through an outlet of the first electrically conductive tube and introducing the second product stream into the product channel through an outlet of the second electrically conductive tube. It should be understood that the process for upgrading hydrocarbons of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

Specific embodiments will now be described with references to the figures.

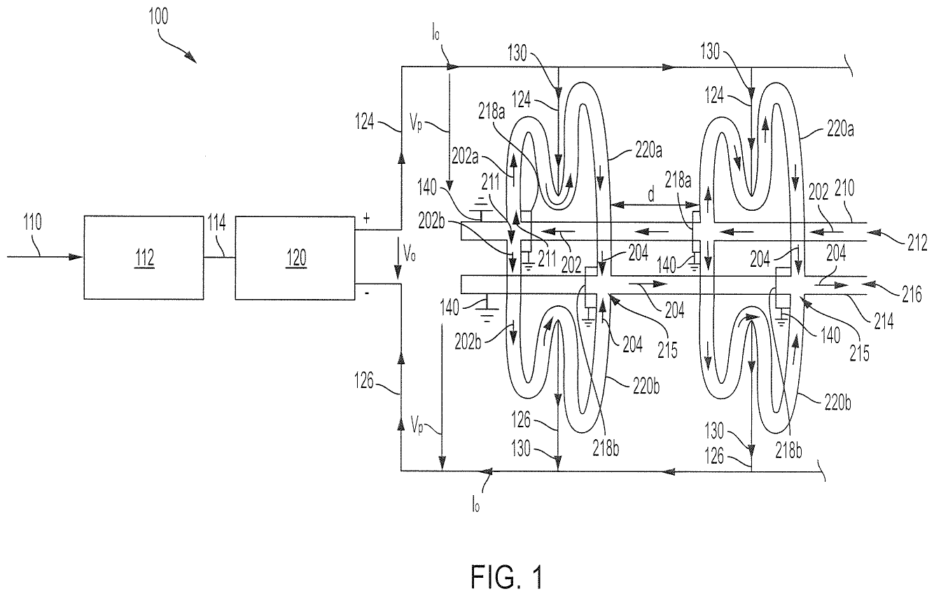

FIG. 1 schematically depicts a heating apparatus 100 for upgrading hydrocarbons from a hydrocarbon fluid 202, according to embodiments described herein.

The heating apparatus 100 includes a pair of electrically conductive tubes (as shown in FIG. 1, the pair may include 220a and 220b), a feed channel 210, a product channel 214, and a DC current voltage source 120. The feed channel 210 has a fluid entrance 212 and a grounded connection 140 and is fluidly connected to inlets 211 of the pair of electrically conductive tubes 220a, 220b. Similarly, the product channel 214 has a fluid exit 216 and a grounded connection 140 and is fluidly connected to outlets 215 of the pair of electrically conductive tubes 220a, 220b.

In embodiments, a power feed 110 may be provided to a transformer 112. The transformer 112 may be any transformer known in the art that transfers electrical energy from one electrical circuit to another circuit. In embodiments, the transformer 112 may be a power step-down transformer that decreases the voltage level of the power to form a decreased voltage power 114 that is provided to the DC current voltage source 120. A power step-down transformer 112 and an associated DC current voltage source 120 may use semiconductor technology such as Thyristor, Diode, Insulated-gate Bipolar Transistor (IGBT), Integrated Gate-Commutated Thyristor (IGCT), which are commercially available by companies such as Fuji Electric or ABB and are commonly used by the electro-chemical or metals industries. It should be understood that although the transformer 112 and the DC current voltage source 120 are depicted for clarity as separate units in FIG. 1, in embodiments these components may be integrated into a single unit.

As shown in FIG. 1, the pair of electrically conductive tubes includes a first electrically conductive tube 220a and a second electrically conductive tube 220b connected in series. As used throughout this disclosure, 220a and 220b will be used to refer to the terms “first electrically conductive tube” and “second electrically conductive tube,” respectively, as to refer to a pair of electrically conductive tubes or to each component of a pair of electrically conductive tubes; however, this is not meant to limit to specifically one pair of electrically conductive tubes or to a first pair of electrically conductive tubes, rather, this is meant to refer to any pair or component of a pair of electrically conductive tubes in general. In embodiments (as shown in FIG. 1), there may be additional pairs of electrically conductive tube, such as a second pair including 220a and 220b. In embodiments (not shown), there may be more than 2 pairs of electrically conductive tube. In embodiments, the heating apparatus 100 may include from 2 to 100 pairs, from 2 to 75 pairs, from 2 to 60 pairs, from 2 to 50 pairs, from 2 to 40 pairs, from 2 to 35 pairs, from 2 to 30 pairs, from 2 to 25 pairs, from 2 to 20 pairs, from 2 to 15 pairs, from 2 to 10 pairs, from 2 to 5 pairs, from 5 to 100 pairs, from 5 to 75 pairs, from 5 to 60 pairs, from 5 to 50 pairs, from 5 to 40 pairs, from 5 to 35 pairs, from 5 to 30 pairs, from 5 to 25 pairs, from 5 to 20 pairs, from 5 to 15 pairs, from 5 to 10 pairs, from 10 to 100 pairs, from 10 to 75 pairs, from 10 to 60 pairs, from 10 to 50 pairs, from 10 to 40 pairs, from 10 to 35 pairs, from 10 to 30 pairs, from 10 to 25 pairs, from 10 to 20 pairs, from 10 to 15 pairs, from 15 to 100 pairs, from 15 to 75 pairs, from 15 to 60 pairs, from 15 to 50 pairs, from 15 to 40 pairs, from 15 to 35 pairs, from 15 to 30 pairs, from 15 to 25 pairs, from 15 to 20 pairs, from 20 to 100 pairs, from 20 to 75 pairs, from 20 to 60 pairs, from 20 to 50 pairs, from 20 to 40 pairs, from 20 to 35 pairs, from 20 to 30 pairs, from 20 to 25 pairs, from 25 to 100 pairs, from 25 to 75 pairs, from 25 to 60 pairs, from 25 to 50 pairs, from 25 to 40 pairs, from 25 to 35 pairs, from 25 to 30 pairs, from 30 to 100 pairs, from 30 to 75 pairs, from 30 to 60 pairs, from 30 to 50 pairs, from 30 to 40 pairs, from 30 to 35 pairs, from 35 to 100 pairs, from 35 to 75 pairs, from 35 to 60 pairs, from 35 to 50 pairs, from 35 to 40 pairs, from 40 to 100 pairs, from 40 to 75 pairs, from 40 to 60 pairs, from 40 to 50 pairs, from 50 to 100 pairs, from 50 to 75 pairs, from 50 to 60 pairs, from 60 to 100 pairs, from 60 to 75 pairs, or from 75 to 100 pairs of electrically conductive tubes. In embodiments where the heating apparatus 100 includes at least 2 pairs of electrically conductive tubes, a first pair of electrically conductive tubes and a second pair of electrically conductive tubes may be physically arranged in parallel to each other separated by distance (d) on a horizontal axis, as shown.

In embodiments, the first electrically conductive tube, the second electrically conductive tube, or both may have a curve along the length of the electrically conductive tube. The shape of each electrically conductive tube can vary to resemble, for example, the letter M, W, U, inverted U, I, or combinations thereof. It is desirable for each electrically conductive tube connected to the power feed 110 to have similar shape and geometries and made with similar materials and having electrical resistance value within plus or minus 10% of a specified range for new materials at room temperature and at operating temperature, to ensure the power output required for each electrically conductive tube is within a desirable range of approximately +/−11%, thus ensuring the heat flux to all conduits are within a narrower range (plus or minus 11% of mean value) compared to heat fluxes delivered to conduits in existing conventional combustion fired furnaces (which can vary by as much as 100% across an entire furnace). The uniform heat flux of the electrically conductive tubes provides a more uniform conduit temperature such that the maximum conduit temperature-both along a single conduit and across neighboring conduits in the furnace—is reduced compared to the maximum conduit temperature found in conventional combustion furnaces. A reduction in the maximum conduit temperature can permit an increase in the average conduit temperature, which will improve the conversion of reactants and increase the selectivity to desired products (ethylene). It follows that the improved control of the maximum temperature of conductive cracking conduits will result in lower rates of coke build-up on the inner conduit wall. Conduits that operate free of coke buildup exhibit higher heat transfer rates contribute to conduit cooling, further limiting conduit overheating. Reduced coking rates leads to longer operational runtimes, decreasing the frequency of costly furnace shutdowns needed for de-coking of the conduits, and hence longer overall conduit lifetimes can be expected from use of electrically conductive tubes.

In embodiments, any pair of electrically conductive tubes may have an electric resistivity of from 1.0 to 4.0μΩ·m at 900° C., from 1.0 to 3.5μΩ·m at 900° C., from 1.0 to 3.0μΩ·m at 900° C., from 1.0 to 2.5μΩ·m at 900° C., from 1.0 to 2.0μΩ·m at 900° C., from 1.0 to 1.5μΩ·m at 900° C., from 1.5 to 4.0μΩ·m at 900° C., from 1.5 to 3.5μΩ·m at 900° C., from 1.5 to 3.0μΩ·m at 900° C., from 1.5 to 2.5μΩ·m at 900° C., from 1.5 to 2.0μΩ·m at 900° C., from 2.0 to 4.0μΩ·m at 900° C., from 2.0 to 3.5μΩ·m at 900° C., from 2.0 to 3.0μΩ·m at 900° C., from 2.0 to 2.5μΩ·m at 900° C., from 2.5 to 4.0 μΩ·m at 900° C., from 2.5 to 3.5 μΩ·m at 900° C., from 2.5 to 3.0 μΩ·m at 900° C., from 3.0 to 4.0μΩ·m at 900° C., from 3.0 to 3.5μΩ·m at 900° C., or from 3.5 to 4.0μΩ·m at 900° C. In embodiments, the electric resistivity of an electrically conductive tube may vary over the length of an electrically conductive tube.

In embodiments, any electrically conductive tube may have an inner diameter of from 1 to 6 inches (in), from 1 to 5 in, from 1 to 4 in, from 1 to 3 in, from 1 to 2 in, from 2 to 6 in, from 2 to 5 in, from 2 to 4 in, from 2 to 3 in, from 3 to 6 in, from 3 to 5 in, from 3 to 4 in, from 4 to 6 in, from 4 to 5 in, or from 5 to 6 in. Any electrically conductive tube may have a wall thickness of from 0.1 to 1.5 in, from 0.1 to 1.25 in, from 0.1 to 1.0 in, from 0.1 to 0.75 in, from 0.1 to 0.5 in, from 0.1 to 0.25 in, from 0.25 to 1.5 in, from 0.25 to 1.25 in, from 0.25 to 1.0 in, from 0.25 to 0.75 in, from 0.25 to 0.5 in, from 0.5 to 1.5 in, from 0.5 to 1.25 in, from 0.5 to 1.0 in, from 0.5 to 0.75 in, from 0.75 to 1.5 in, from 0.75 to 1.25 in, from 0.75 to 1.0 in, from 1.0 to 1.5 in, from 1.0 to 1.25 in, or from 1.25 to 1.5 in. Any electrically conductive tube may have a length of 10 to 60 meters (m), from 10 to 50 m, from 10 to 40 m, from 10 to 30 m, from 10 to 20 m, from 20 to 60 m, from 20 to 50 m, from 20 to 40 m, from 20 to 30 m, from 30 to 60 m, from 30 to 50 m, from 30 to 40 m, from 40 to 60 m, from 40 to 50 m, or from 50 to 60 m. In embodiments, the inner diameter, the wall thickness, or both may vary over the length of an electrically conductive tube.

As referenced previously, various properties of the electrically conductive tubes may be modified to deliver different heat loads to different sections of the electrically conductive tube. It is contemplated that modifying the properties of the electrically conductive tube may result in delivering heat in a way that facilitates improved performance. Tailoring the power and heat load delivered to an electrically conductive tube may be accomplished by adjusting the electrical resistance of a first portion of an electrically conductive tube and the electrical resistance of a second portion of an electrically conductive tube relative to each other. In embodiments, the first portion of any electrically conductive tube may be proximate to the inlet 211. Similarly, the second portion of any electrically conductive tube may be proximate to the outlet 215. The electrical resistance can be adjusted by adjusting the properties of the portions of the electrically conductive tube, where the properties are any of those described herein. It is contemplated that the resistance of each portion of an electrically conductive tube may also be changed by using different materials having different electrical resistivity.

In embodiments, the first electrically conductive tube 220a may be electrically connected to the second electrically conductive tube 220b. In embodiments, a first current bridge link 218a and a second current bridge link 218b are electrically positioned between the first electrically conductive tube 220a and the second electrically conductive tube 220b. The current bridge links 218a, 218b are configured to conduct current across the feed channel 210, the product channel 214, or both. In embodiments, the current bridge links 218a, 218b may be connected to a grounded connection 140, as shown in FIG. 1 where a grounded connection 140 is shown connected to the current bridge link 218a. Although FIG. 1 depicts the grounded connection 140 connected to the current bridge link 218a, it should be understood that there may be additional or alternative grounded connections 140 connected to the other current bridge links 218a, 218b. In embodiments (not shown), each current bridge link 218a, 218b may be connected to a separate or independent grounded connection 140.

The first and second current bridge links 218a, 218b may include materials possessing high melting point, low electrical resistance and are galvanically compatible with the material of the conduits to which they are attached, such as the same material as the conduit. According to embodiments, the first and second current bridge links 218a, 218b are made from material that has an electrical resistivity that is less than or equal to the resistivity of the material used to form the pair of electrically conductive tubes 220a, 220b, to limit excessive heat generated in the current bridge links.

The DC current voltage source 120 is electrically connected to the first electrically conductive tube 220a and the second electrically conductive tube 220b. In embodiments, the pair of electrically conductive tubes 220a, 220b is configured such that DC current 130 generated from the DC current voltage source 120 flows from the first electrically conductive tube 220a to the second electrically conductive tube 220b and from the second electrically conductive tube 220b to the DC current voltage source 120. In embodiments, the DC current 130 may flow from the first electrically conductive tube 220a to the second electrically conductive tube 220b through the first and second current bridge links 218a, 218b.

The DC current voltage source 120 has an output voltage (Vₒ) twice that of the voltage potential (Vₚ) of each electrically conductive tube thus allowing the same amount of DC current 130 to power the pair of electrically conductive tubes 220a, 220b, electrically connected in series. It is contemplated that having the output voltage (Vₒ) be twice that of the voltage potential (Vₚ) of each electrically conductive tube allows the output current (Iₒ) from the DC current voltage source 120 for the pair of electrically conductive tubes 220a, 220b equal to the current of each pipe assembly. This maintains the output current (Iₒ) from the DC current voltage source 120 at a minimum level while allowing the inlets 211 and outlets 215 of the pair of electrically conductive tubes 220a, 220b to be electrically grounded to earth ground through the grounded connection 140 to ensure safe operation while also not requiring the use of electrically isolating means (such as isolation flanges).

As previously stated, the pair of electrically conductive tubes 220a, 220b have inlets 211 and outlets 215. Any electrically conductive tube may have one inlet 211 (as shown) or may have multiple inlets 211 (not shown). In embodiments, any electrically conductive tube may have 2, 3, 4, 5, or 6 inlets 211. Any electrically conductive tube may have one outlet 215 (as shown) or may have multiple outlets 215 (not shown). In embodiments, any electrically conductive tube may have 2, 3, 4, 5, or 6 outlets 215. In embodiments, the inlets 211 of the pair of electrically conductive tubes 220a, 220b each have 0 voltage potential. Additionally or alternatively, in embodiments, the outlets 215 of pair of electrically conductive tubes 220a, 220b each have 0 voltage potential. The inlets 211 and/or the outlets 215 may have 0 voltage potential due to being electrically conductively connected to the grounded connection 140.

The heating apparatus 100 may be further configured to send DC current 130 from the inlet 211 of the first electrically conductive tube 220a across the first current bridge link 218a to the inlet 211 of the second electrically conductive tube 220b. The heating apparatus 100 may be further configured to send DC current 130 from the outlet 215 of the first electrically conductive tube 220a across the second current bridge link 218b to the outlet 215 of the second electrically conductive tube 220b. It is contemplated that the current bridge links 218a, 218b are low resistance paths as compared to the connections between the inlets 211 or the outlets 215; therefore a relatively larger portion of the DC current 130 flows through the current bridge links 218a, 218b than through the connections between the inlets 211 and the outlets 215.

In embodiments, the heating apparatus 100 may further include a positive conductor 124 and a negative conductor 126. In embodiments, the positive conductor 124 electrically connects the DC current voltage source 120 and the first electrically conductive tube 220a. Similarly, the negative conductor 126 may electrically connect the DC current voltage source 120 and the second electrically conductive tube 220b.

In embodiments, the heating apparatus 100 may be configured to send DC current 130 from the DC current voltage source 120 through the positive conductor 124 to the first electrically conductive tube 220a. Additionally or alternatively, the heating apparatus 100 may be configured to send DC current 130 from the second electrically conductive tube 220b through the negative conductor 126 to the DC current voltage source 120.

In embodiments, the positive conductor 124 may be electrically connected to a position of the first electrically conductive tube 220a between the inlet 211 and outlet 215. Similarly, in embodiments, the negative conductor 126 may be electrically connected to a position of the second electrically conductive tube 220b between the inlet 211 and outlet 215. In embodiments, the positive conductor 124 and the negative conductor 126 may be electrically connected at positions approximately halfway along the length of the electrically conductive tube 220a, 220b. In embodiments, the positive conductor 124 and the negative conductor 126 may be electrically connected at positions relatively closer to the inlet 211 than the outlet 215 of the electrically conductive tube 220a, 220b, as shown in FIG. 1. In embodiments where the positive conductor 124 and the negative conductor 126 are electrically connected at positions relatively closer to the inlet 211 than the outlet 215 along the length of the electrically conductive tube 220a, 220b, greater than 50% of the total electrically generated heat per electrically conductive tube 220a, 220b, may be generated in a first half of the electrically conductive tube 220a, 220b. In embodiments, from 50% to 95%, from 50% to 90%, from 50% to 85%, from 50% to 80%, from 50% to 75%, from 50% to 70%, from 50% to 65%, from 50% to 60%, from 50% to 55%, from 55% to 95%, from 55% to 90%, from 55% to 85%, from 55% to 80%, from 55% to 75%, from 55% to 70%, from 55% to 65%, from 55% to 60%, from 60% to 95%, from 60% to 90%, from 60% to 85%, from 60% to 80%, from 60% to 75%, from 60% to 70%, from 60% to 65%, from 65% to 95%, from 65% to 90%, from 65% to 85%, from 65% to 80%, from 65% to 75%, from 65% to 70%, from 70% to 95%, from 70% to 90%, from 70% to 85%, from 70% to 80%, from 70% to 75%, from 75% to 95%, from 75% to 90%, from 75% to 85%, from 75% to 80%, from 80% to 95%, from 80% to 90%, from 80% to 85%, from 85% to 95%, from 85% to 90%, or from 90% to 95% of the total electrically generated heat per electrically conductive tube 220a, 220b, may be generated in a first half of the electrically conductive tube 220a, 220b. In embodiments, the average heat load (total heat divided by the total surface area) along the length of each electrically conductive tube ranges from 10 to 150 kilowatt per square meter (kW/m²), such as from 15 to 150 Kw/m², from 20 to 150 Kw/m², from 25 to 150 Kw/m², from 30 to 150 Kw/m², from 40 to 150 Kw/m², from 50 to 150 Kw/m², from 70 to 150 Kw/m², from 90 to 150 Kw/m², from 100 to 150 Kw/m², from 125 to 150 Kw/m², from 10 to 125 kW/m², from 15 to 125 Kw/m², from 20 to 125 Kw/m², from 25 to 125 Kw/m², from 30 to 125 Kw/m², from 40 to 125 Kw/m², from 50 to 125 Kw/m², from 70 to 125 Kw/m², from 90 to 125 Kw/m², from 100 to 125 Kw/m², from 10 to 100 kW/m², from 15 to 100 Kw/m², from 20 to 100 Kw/m², from 25 to 100 Kw/m², from 30 to 100 Kw/m², from 40 to 100 Kw/m², from 50 to 100 Kw/m², from 70 to 100 Kw/m², from 90 to 100 Kw/m², from 10 to 90 kW/m², from 15 to 90 Kw/m², from 20 to 90 Kw/m², from 25 to 90 Kw/m², from 30 to 90 Kw/m², from 40 to 90 Kw/m², from 50 to 90 Kw/m², from 70 to 90 Kw/m², from 10 to 70 kW/m², from 15 to 70 Kw/m², from 20 to 70 Kw/m², from 25 to 70 Kw/m², from 30 to 70 Kw/m², from 40 to 70 Kw/m², from 50 to 70 Kw/m², from 10 to 50 kW/m², from 15 to 50 Kw/m², from 20 to 50 Kw/m², from 25 to 50 Kw/m², from 30 to 50 Kw/m², from 40 to 50 Kw/m², from 10 to 40 kW/m², from 15 to 40 Kw/m², from 20 to 40 Kw/m², from 25 to 40 Kw/m², from 30 to 40 Kw/m², from 10 to 30 kW/m², from 15 to 30 Kw/m², from 20 to 30 Kw/m², from 25 to 30 Kw/m², from 10 to 25 kW/m², from 15 to 25 Kw/m², from 20 to 25 Kw/m², from 10 to 20 kW/m², from 15 to 20 Kw/m², or from 10 to 15 kW/m².

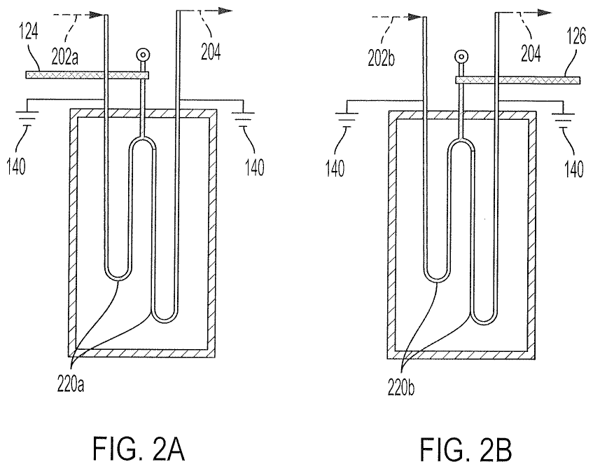

The above heating apparatus 100 according to embodiments disclosed and described herein will now further be defined with reference to FIG. 2A and FIG. 2B, which are side views of the heating apparatus 100 according to one or more embodiments. As shown in FIG. 2A, grounded connections 140 are electrically connected to the left and right side the first electrically conductive tube 220a. Moreover, a positive conductor 124 is connected to the middle of the first electrically conductive tube 220a to provide an electrical current to the first electrically conductive tube 220a. As a result of the electrical resistance of the first electrically conductive tube 220a, applying electrical current via the positive conductor 124 to the first electrically conductive tube 220a causes the temperature of the first electrically conductive tube 220a to increase, thereby heating the first portion of the hydrocarbon fluid 202a that enters the first electrically conductive tube 220a on the left side of FIG. 2A. The first portion of the hydrocarbon fluid 202a reacts within the first electrically conductive tube 220a to form a product stream 204.

As shown in FIG. 2B, grounded connections 140 are electrically connected to the left and right side the second electrically conductive tube 220b. Moreover, a negative conductor 126 is connected to the middle of the second electrically conductive tube 220b to provide an electrical circuit with the first electrically conductive tube 220a and the positive conductor 124 depicted in FIG. 2A. With reference again to FIG. 2B, as a result of the electrical resistance of the second electrically conductive tube 220b, applying electrical current via the circuit formed by the positive conductor 124, the first electrically conductive tube 220a, the second electrically conductive tube 220b, and the negative conductor 126 causes the temperature of the second electrically conductive tube 220b to increase, thereby heating the second portion of the hydrocarbon fluid 202b that enters the second electrically conductive tube 220b on the left side of FIG. 2B. The second portion of the hydrocarbon fluid 202b reacts within the second electrically conductive tube 220b to form a product stream 204.

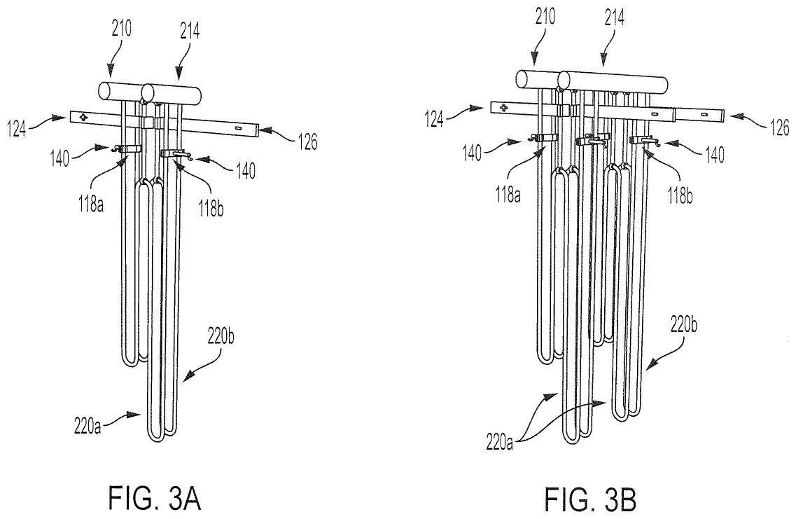

The heating apparatus 100 according to embodiments disclosed and described herein will further be defined with reference to FIG. 3A and FIG. 3B, which are perspective views of the heating apparatus 100 according to one or more embodiments. As shown in FIG. 3A, a first electrically conductive tube 220a and electrically conductive tube 220b are each fluidly connected to a feed channel 210 on the left side of FIG. 3A where a first portion of hydrocarbon fluid 202a (not shown) enters the first electrically conductive tube 220a and a second portion of hydrocarbon fluid 202b (not shown) enters the second electrically conductive tube 220b. Similarly, the first electrically conductive tube 220a and the second electrically conductive tube 220b are fluidly connected to a product channel 214 where product stream 204 (not shown) exits the first electrically conductive tube 220a and the second electrically conductive tube 220b. The positive conductor 124 is electrically connected to the first electrically conductive tube 220a to provide electrical current to the first electrically conductive tube 220a, thereby causing the temperature of the first electrically conductive tube 220a to increase as a result of its electrical resistance. A first current bridge link 118a and a second current bridge link 118b electrically connect the first electrically conductive tube 220a and the second electrically conductive tube 220b, thereby allowing electrical current to more easily flow between the first electrically conductive tube 220a and the second electrically conductive tube 220b. It should be appreciated that the first current bridge link 118a and the second current bridge link 118b may be present in the embodiments shown in FIG. 2A and FIG. 2B, but would not be visible in a side view. Referring again to FIG. 3A, grounded connections 140 are electrically connected to the first current bridge link 118a and the second current bridge link 118b. The second electrically conductive tube 220b is electrically connected to a negative conductor 126, thereby completing an electrical circuit between the positive conductor 124, the first electrically conductive tube 220a, the first current bridge link 118a, the second current bridge link 118b, the second electrically conductive tube 220b, and the negative conductor 126.

As shown in FIG. 3B, a plurality of first electrically conductive tubes 220a and a plurality of electrically conductive tubes 220b are each fluidly connected to a feed channel 210 on the left side of FIG. 3B where a first portion of hydrocarbon fluid 202a enter the plurality of first electrically conductive tubes 220a and a second portion of hydrocarbon fluid 202b enters the plurality of second electrically conductive tubes 220b. Similarly, the plurality of first electrically conductive tubes 220a and the plurality of second electrically conductive tubes 220b are fluidly connected to a product channel 214 where product stream 204 exits the plurality of first electrically conductive tubes 220a and the plurality of second electrically conductive tubes 220b. A plurality of positive conductors 124 are electrically connected to the plurality of first electrically conductive tubes 220a to provide electrical current to the plurality of first electrically conductive tubes 220a, thereby causing the temperature of the plurality of first electrically conductive tubes 220a to increase as a result of their electrical resistance. A plurality of first current bridge links 118a and a plurality of second current bridge links 118b electrically connect the plurality of first electrically conductive tubes 220a and the plurality of second electrically conductive tubes 220b, thereby allowing electrical current to more easily flow between the plurality of first electrically conductive tubes 220a and the plurality of second electrically conductive tubes 220b. Grounded connections 140 are electrically connected to the plurality of first current bridge links 118a and the plurality of second current bridge links 118b. The plurality of second electrically conductive tubes 220b are electrically connected to a plurality of negative conductors 126, thereby completing an electrical circuit between the plurality of positive conductors 124, the plurality of first electrically conductive tubes 220a, the plurality of first current bridge links 118a, the plurality of second current bridge links 118b, the plurality of second electrically conductive tubes 220b, and plurality of the negative conductors 126.

This disclosure is also directed towards processes for upgrading hydrocarbon fluids using the heating apparatuses described herein. The processes may use any of the heating apparatuses previously described in this disclosure.

A process for upgrading a hydrocarbon fluid 202 includes introducing the hydrocarbon fluid 202 into the fluid entrance 212 of the feed channel 210 and introducing the hydrocarbon fluid 202 into the pair of electrically conductive tubes 220a. 220b. In embodiments, the hydrocarbon fluid 202 may include from 60 to 99 wt. %, from 60 to 95 wt. %, from 60 to 85 wt. %, from 60 to 80 wt. %, from 60 to 75 wt. %, from 60 to 70 wt. %, from 60 to 65 wt. %, from 65 to 99 wt. %, from 65 to 95 wt. %, from 65 to 85 wt. %, from 65 to 80 wt. %, from 65 to 75 wt. %, from 65 to 70 wt. %, from 70 to 99 wt. %, from 70 to 95 wt. %, from 70 to 85 wt. %, from 70 to 80 wt. %, from 70 to 75 wt. %, from 75 to 99 wt. %, from 75 to 95 wt. %, from 75 to 85 wt. %, from 75 to 80 wt. %, from 80 to 99 wt. %, from 80 to 95 wt. %, from 80 to 85 wt. %, from 85 to 99 wt. %, from 85 to 95 wt. %, from 85 to 90 wt. %, from 90 to 95 wt. %, or from 95 to 99 wt. % paraffins. The hydrocarbon fluid 202 may be a gas, a liquid, or a combination of the two. In embodiments, the paraffins may include acyclic saturated hydrocarbons such as methane, ethane, propane, butane, pentane, hexane, or combinations thereof.

Introducing the hydrocarbon fluid 202 into the pair of electrically conductive tubes 220a, 220b includes introducing a first portion of the hydrocarbon fluid 202a into the inlet 211 of the first electrically conductive tube 220a and introducing a second portion of the hydrocarbon fluid 202b into the inlet 211 of the second electrically conductive tube 220b. It should be understood that similar flow will occur with additional pairs of electrically conductive tubes. In embodiments, the process may include additional pairs of electrically conductive tubes as previously described.

The process further includes applying DC current 130 to the first electrically conductive tube 220a to heat the first portion of the hydrocarbon fluid 202a within the first electrically conductive tube 220a to reaction temperature to form a first product stream 204. The process further includes applying DC current 130 to the second electrically conductive tube 220b to heat the second portion of the hydrocarbon fluid 202b within the second electrically conductive tube 220b to reaction temperature to form a second product stream 204. In embodiments, heating the first portion of the hydrocarbon fluid 202a and heating the second portion of the hydrocarbon fluid 202b includes heating to from 600° C. to 900° C., from 600° C. to 850° C., from 600° C. to 800° C., from 600° C. to 750° C., from 600° C. to 700° C., from 600° C. to 650° C., from 650° C. to 900° C., from 650° C. to 850° C., from 650° C. to 800° C., from 650° C. to 750° C., from 650° C. to 700° C., from 700° C. to 900° C., from 700° C. to 850° C., from 700° C. to 800° C., from 700° C. to 750° C., from 750° C. to 900° C., from 750° C. to 850° C. from 750° C. to 800° C., from 800° C. to 900° C., from 800° C. to 850° C., or from 850° C. to 900° C.

In embodiments, the process may additionally include sending the DC current 130 from the DC current voltage source 120 through the positive conductor 124 to the first electrically conductive tube 220a and sending the DC current 130 from the first electrically conductive tube 220a to the second electrically conductive tube 220b. The process may further include sending the DC current 130 from the second electrically conductive tube 220b through the negative conductor 126 to the DC current voltage source 120.

In embodiments, applying the DC current 130 to the electrically conductive tube 220 provides greater than 50%, from 50% to 95%, from 50% to 85%, from 50% to 80%, from 50% to 75%, from 50% to 70%, from 50% to 65%, from 50% to 60%, from 50% to 55%, from 55% to 95%, from 55% to 85%, from 55% to 80%, from 55% to 75%, from 55% to 70%, from 55% to 65%, from 55% to 60%, from 60% to 95%, from 60% to 85%, from 60% to 80%, from 60% to 75%, from 60% to 70%, from 60% to 65%, from 65% to 95%, from 65% to 85%, from 65% to 80%, from 65% to 75%, from 65% to 70%, from 70% to 95%, from 70% to 85%, from 70% to 80%, from 70% to 75%, from 75% to 95%, from 75% to 85%, from 75% to 80%, from 80% to 95%, from 80% to 85%, from 85% to 95%, from 85% to 90%, or from 90% to 95% of the total heat load in a first half of the electrically conductive tube 220. Specifically, in embodiments, applying the DC current 130 to the first electrically conductive tube 220a provides greater than 50% of the total heat load in a first half of the first electrically conductive tube 220a. Similarly, in embodiments, applying the DC current to the second electrically conductive tube 220b provides greater than 50%, from 50% to 95%, from 50% to 85%, from 50% to 80%, from 50% to 75%, from 50% to 70%, from 50% to 65%, from 50% to 60%, from 50% to 55%, from 55% to 95%, from 55% to 85%, from 55% to 80%, from 55% to 75%, from 55% to 70%, from 55% to 65%, from 55% to 60%, from 60% to 95%, from 60% to 85%, from 60% to 80%, from 60% to 75%, from 60% to 70%, from 60% to 65%, from 65% to 95%, from 65% to 85%, from 65% to 80%, from 65% to 75%, from 65% to 70%, from 70% to 95%, from 70% to 85%, from 70% to 80%, from 70% to 75%, from 75% to 95%, from 75% to 85%, from 75% to 80%, from 80% to 95%, from 80% to 85%, from 85% to 95%, from 85% to 90%, or from 90% to 95% of the total heat load in a first half of the second electrically conductive tube 220b.

The process further includes introducing the first product stream 204 into the product channel 214 through the outlet 215 of the first electrically conductive tube 220a and introducing the second product stream 204 into the product channel 214 through the outlet 215 of the second electrically conductive tube 220b. The first and second product streams 204 may include olefins such as ethylene, propylene, 1-butene, 2-butene, isobutylene, 1-pentene, 2-pentene, 2-methyl-1-butene, 3-methyl-1-butene, 2-methyl-2-butene, or combinations thereof. In embodiments, the first product stream 204 and the second product stream 204 may include greater than 20 wt. %, greater than 25 wt. %, greater than 30 wt. %, greater than 35 wt. %, or greater than 40 wt. % olefins. In embodiments, the first product stream 204 and the second product stream 204 may include from 20 to 100 wt. %, from 20 to 95 wt. %, from 20 to 90 wt. %, from 20 to 85 wt. %, from 20 to 80 wt. %, from 20 to 75 wt. %, from 20 to 70 wt. %, from 20 to 65 wt. %, from 20 to 60 wt. %, from 20 to 55 wt. %, from 20 to 50 wt. %, from 20 to 45 wt. %, from 20 to 40 wt. %, from 20 to 35 wt. %, from 20 to 30 wt. %, from 20 to 25 wt. %, from 25 to 100 wt. %, from 25 to 95 wt. %, from 25 to 90 wt. %, from 25 to 85 wt. %, from 25 to 80 wt. %, from 25 to 75 wt. %, from 25 to 70 wt. %, from 25 to 65 wt. %, from 25 to 60 wt. %, from 25 to 55 wt. %, from 25 to 50 wt. %, from 25 to 45 wt. %, from 25 to 40 wt. %, from 25 to 35 wt. %, from 25 to 30 wt. %, from 30 to 100 wt. %, from 30 to 95 wt. %, from 30 to 90 wt. %, from 30 to 85 wt. %, from 30 to 80 wt. %, from 30 to 75 wt. %, from 30 to 70 wt. %, from 30 to 65 wt. %, from 30 to 60 wt. %, from 30 to 55 wt. %, from 30 to 50 wt. %, from 30 to 45 wt. %, from 30 to 40 wt. %, from 30 to 35 wt. %, from 35 to 100 wt. %, from 35 to 95 wt. %, from 35 to 90 wt. %, from 35 to 85 wt. %, from 35 to 80 wt. %, from 35 to 75 wt. %, from 35 to 70 wt. %, from 35 to 65 wt. %, from 35 to 60 wt. %, from 35 to 55 wt. %, from 35 to 50 wt. %, from 35 to 45 wt. %, from 35 to 40 wt. %, from 40 to 100 wt. %, from 40 to 95 wt. %, from 40 to 90 wt. %, from 40 to 85 wt. %, from 40 to 80 wt. %, from 40 to 75 wt. %, from 40 to 70 wt. %, from 40 to 65 wt. %, from 40 to 60 wt. %, from 40 to 55 wt. %, from 40 to 50 wt. %, from 40 to 45 wt. %, from 45 to 100 wt. %, from 45 to 95 wt. %, from 45 to 90 wt. %, from 45 to 85 wt. %, from 45 to 80 wt. %, from 45 to 75 wt. %, from 45 to 70 wt. %, from 45 to 65 wt. %, from 45 to 60 wt. %, from 45 to 55 wt. %, from 45 to 50 wt. %, from 50 to 100 wt. %, from 50 to 95 wt. %, from 50 to 90 wt. %, from 50 to 85 wt. %, from 50 to 80 wt. %, from 50 to 75 wt. %, from 50 to 70 wt. %, from 50 to 65 wt. %, from 50 to 60 wt. %, from 50 to 55 wt. %, from 55 to 100 wt. %, from 55 to 95 wt. %, from 55 to 90 wt. %, from 55 to 85 wt. %, from 55 to 80 wt. %, from 55 to 75 wt. %, from 55 to 70 wt. %, from 55 to 65 wt. %, from 55 to 60 wt. %, from 60 to 100 wt. %, from 60 to 95 wt. %, from 60 to 90 wt. %, from 60 to 85 wt. %, from 60 to 80 wt. %, from 60 to 75 wt. %, from 60 to 70 wt. %, from 60 to 65 wt. %, from 65 to 100 wt. %, from 65 to 95 wt. %, from 65 to 90 wt. %, from 65 to 85 wt. %, from 65 to 80 wt. %, from 65 to 75 wt. %, from 65 to 70 wt. %, from 70 to 100 wt. %, from 70 to 95 wt. %, from 70 to 90 wt. %, from 70 to 85 wt. %, from 70 to 80 wt. %, from 70 to 75 wt. %, from 75 to 100 wt. %, from 75 to 95 wt. %, from 75 to 90 wt. %, from 75 to 85 wt. %, from 75 to 80 wt. %, from 80 to 100 wt. %, from 80 to 95 wt. %, from 80 to 90 wt. %, from 80 to 85 wt. %, from 85 to 100 wt. %, from 85 to 95 wt. %, from 85 to 90 wt. %, from 90 to 100 wt. %, from 90 to 95 wt. %, or from 95 to 100 wt. % olefins.

### Examples

A process for upgrading hydrocarbons was calculated using a cracking conduit having a single constant heat flux along the entire conduit length and an electrically conductive tube with a dual heating zone consisting of higher heating in the entry portion of the conduit followed directly by a zone of the conduit having a lower heat flux in accordance with the embodiments described above.

The single heating zone cracking conduit had an inside diameter of 3″, a wall thickness of 0.355″, a length of 40.5 m, and an electric resistivity of 1.494 μΩ-m at 900° C. A temperature dependent electrical resistivity was assumed. The conduit was connected to a 132 V DC potential to one end of the tube pass and 0 V to the other end of the pass. Total current (Iₒ) was 4892 amps. This configuration has a uniform heat generation rate throughout the conduit. Hydrocarbon fluid was then flowed through the conventional cracking conduit with a flow rate of 793.7 Kg/hr and inlet temperature of 675° C. The hydrocarbon fluid included 80 wt. % ethane and 20 wt. % steam.

The electrically conductive tube having a dual-zone heat flux had an inside diameter of 3″, a length of 40.5 m, and an electric resistivity of 1.494 μΩ-m at 900° C. A temperature dependent electrical resistivity was assumed. A DC electric potential difference of 122 V was applied to the tube pair electrically connected in series at to a location 17.5 m away from the inlet. The wall thickness was 0.5″ in the first electrically conductive tube, and 0.3″ for the rest of the electrically conductive tube. Hydrocarbon fluid was then flowed through the conventional cracking conduit with a flow rate of 793.7 Kg/hr and inlet temperature of 675° C. The hydrocarbon fluid included 80 wt. % ethane and 20 wt. % steam. The electric potential field, DC current, process flow and cracking reactions were simulated using a Computational Fluid Dynamics (CFD) model via Fluent V.19.4. The electric heat generated in the first 50% of the electrically conductive tube volume accounted for 73% of the total heat of the length of the electrically conductive tube. The computed temperature and pressure field was then applied to a one-dimensional kinetics model to further confirm the cracking performance.

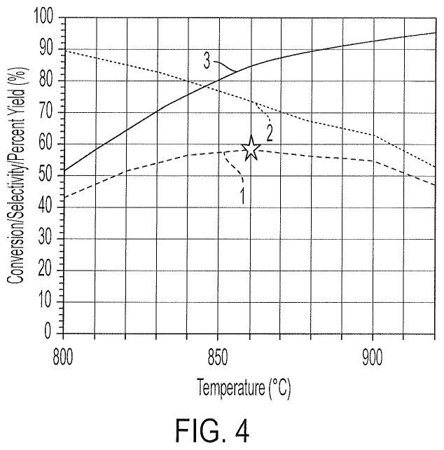

FIG. 4 is a graphical depiction of ethylene yield over cracking for a simulated system based on reaction kinetics; it represents how yield changes with cracking temperature achieved by systems disclosed and described herein with a constant hydrocarbon residence time. Specifically, curve 1 shows the ethylene yield, curve 2 shows the C₂H₄ selectivity, and curve 3 shows the C₂H₆ selectivity. For the example described above, the star on FIG. 4 highlights the inflection point of curve 1 at the greatest effluent ethylene mass fraction and the corresponding favorable reaction temperature. It will be exhibited in the results summary of the present example below that the heat load configuration and electric potential arrangement in an electrically conductive tube, a favorable reaction temperature and higher process yield are achieved.

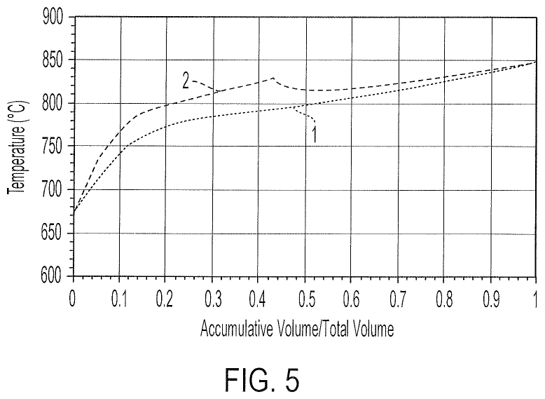

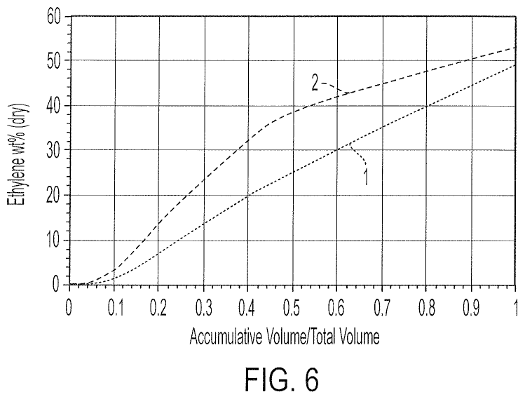

The results are summarized in Table 1 below and FIGS. 5 and 6. The process pressure drop across the length of the conduit was about 7.5 pounds per square inch differential (psid) for both the single-heating zone cracking conduit and the dual-heating zone electrically conductive tube. FIG. 5 compares the predicted process gas temperature profile, where curve 1 is the single-heating zone cracking conduit and curve 2 is the dual-heating zone (example of multiple-heating zone) electrically conductive tube of the present disclosure, where the latter shows a process gas temperature closest to the favorable reaction temperature. FIG. 6 compares the ethylene dry mass fraction along the length of the conduit, where curve 1 is the single-heating zone cracking conduit and curve 2 is the dual-heating zone electrically conductive tube of the present disclosure. It was observed that the dual-heating zone electrically conductive tube increased the temperature of the hydrocarbon fluid more rapidly than the single-zone cracking conduit, and then maintained the temperature of the hydrocarbon fluid within a narrow range after the initial heating. It was determined that the dual-zone electrically conductive tube resulted in an effluent ethylene mass fraction of 52.8 wt. % (dry), and the single-zone cracking conduit resulted in an effluent ethylene mass fraction of 49.2 wt. % (dry), as shown in Table 1 below.

TABLE 1
Summary of Modeling Results

| | Cracking conduit with | Electrically conductive tube |
|---|---|---|
| | a single uniform | with dual heating zone |
| | heating zone | (Present Disclosure) |
| Tout [C.] | 850 | 850 |
| Ethane Conversion | 65.6 | 73.8 |
| [%] | | |
| Effluent | 49.2 | 52.8 |
| Ethylene Mass | | |
| Fraction (wt %- | | |
| dry) | | |

It should be apparent to those skilled in the art that various modifications can be made to the described embodiments without departing from the spirit and scope of the claimed subject matter. Thus, it is intended that the specification cover modifications and variations of the described embodiments provided such modification and variations come within the scope of the appended claims and their equivalents.

1. A heating apparatus comprising:
a pair of electrically conductive tubes,
a feed channel having a fluid entrance and a grounded connection,
a product channel having a fluid exit and a grounded connection, wherein:
the feed channel is fluidly connected to inlets of the pair of electrically conductive tubes;
the product channel is fluidly connected to outlets of the pair of electrically conductive tubes;
a DC current voltage source, wherein:
the pair of electrically conductive tubes comprise a first electrically conductive tube and a second electrically conductive tube connected in series;
the DC current voltage source is electrically connected to the first electrically conductive tube and the second electrically conductive tube.

2. The heating apparatus of claim 1, wherein the first electrically conductive tube is electrically connected to the second electrically conductive tube.

3. The heating apparatus of claim 1, wherein the pair of electrically conductive tubes is configured such that DC current generated from the DC current voltage source flows from the first electrically conductive tube to the second electrically conductive tube and from the second electrically conductive tube to the DC current voltage source.

4. The heating apparatus of claim 1, wherein the heating apparatus further comprises a positive conductor and a negative conductor.

5. The heating apparatus of claim 4, wherein the positive conductor electrically connects the DC current voltage source and the first electrically conductive tube and the negative conductor electrically connects the DC current voltage source and the second electrically conductive tube.

6. The heating apparatus of claim 5, wherein the heating apparatus is configured to:
send DC current from the DC current voltage source through the positive conductor to the first electrically conductive tube;
send DC current from:
an inlet of the first electrically conductive tube across a first current bridge link to an inlet of the second electrically conductive tube,
an outlet of the first electrically conductive tube across a second current bridge link to an outlet of the second electrically conductive tube,
or both;
send DC current from:
the inlet of the first electrically conductive tube across the feed channel to the inlet of the second electrically conductive tube,
the outlet of the first electrically conductive tube across the product channel to the outlet of the second electrically conductive tube,
or both; and
send DC current from the second electrically conductive tube through the negative conductor to the DC current voltage source.

7. The heating apparatus of claim 5, wherein the positive conductor is electrically connected to a position of the first electrically conductive tube between an inlet of the first electrically conductive tube and an outlet of the first electrically conductive tube and the negative conductor is electrically connected to a position of the second electrically conductive tube between an inlet of the second electrically conductive tube and an outlet of the second electrically conductive tube.

8. The heating apparatus of claim 1, wherein:
the inlet of the first electrically conductive tube and the inlet of the second electrically conductive tube each have 0 voltage potential; and
the outlet of the first electrically conductive tube and the outlet of the second electrically conductive tube each have 0 voltage potential.

9. The heating apparatus of claim 1, wherein the heating apparatus is configured to:
introduce a hydrocarbon fluid into the fluid entrance of the feed channel;
introduce a first portion of the hydrocarbon fluid into an inlet of the first electrically conductive tube;
introduce a second portion of the hydrocarbon fluid into an inlet of the second electrically conductive tube;
apply DC current to the first electrically conductive tube to heat the first portion of the hydrocarbon fluid within the first electrically conductive tube to reaction temperature to form a first product stream;
apply DC current to the second electrically conductive tube to heat the second portion of the hydrocarbon fluid within the second electrically conductive tube to reaction temperature to form a second product stream;
introduce the first product stream into the product channel through an outlet of the first electrically conductive tube; and
introduce the second product stream into the product channel through an outlet of the second electrically conductive tube.

10. The heating apparatus of claim 1, wherein a first current bridge link and a second current bridge link are electrically positioned between the first electrically conductive tube and the second electrically conductive tube.

11. The heating apparatus of claim 10, the heating apparatus comprises at least 2 pairs of electrically conductive tubes and a first pair of electrically conductive tubes and a second pair of electrically conductive tubes are physically arranged in parallel to each other separated by distance (d) on a horizontal axis.

12. The heating apparatus of claim 1, wherein a length of the first electrically conductive tube, the second electrically conductive tube, or both comprises a curve.

13. The heating apparatus of claim 1, wherein the heating apparatus comprises from 2 to 100 pairs of electrically conductive tubes.

14. The heating apparatus of claim 1, wherein the heating apparatus comprises from 5 to 35 pairs of electrically conductive tubes.

15. The heating apparatus of claim 1, wherein the pair of electrically conductive tubes have an electric resistivity of from 1.0 μΩ·m to 4.0 μΩ·m at 900° C.
